(19) United States
(12) Patent Application Publication
(10) Pub. No.: US 2018/0255962 A1
(43) Pub. Date: Sep. 13, 2018

(54) METHOD AND DEVICE FOR PREPARING A COFFEE DRINK

(71) Applicant: Franke Kaffeemaschinen AG, Aarburg (CH)

(72) Inventors: Heinz Vetterli, Wangen (CH); Simon Muller, Unterentfelden (CH); Mariano Turi, Zurich (CH)

(73) Assignee: Franke Kaffeemaschinen AG, Aarburg (CH)

(21) Appl. No.: 15/760,889

(22) PCT Filed: Sep. 13, 2016
(86) PCT No.: PCT/EP2016/071586

§ 371 Date: Mar. 16, 2018

(30) Foreign Application Priority Data
Sep. 18, 2015 (DE) 10 2015 217 999.0

(51) Int. Cl. A47J 31/52; A47J 31/00; A47J 31/36; A23F 5/26

(52) U.S. Cl. CPC A47J 31/52; A23F 5/262; A47J 31/3623; A47J 31/002

(57) ABSTRACT

A method for preparing a coffee drink is provided in which, in a brewing process, a pre-specifiable total amount of brewing water is conducted through an amount of powdered coffee. In order to improve the tasting quality of freshly-brewed coffee drinks while, at least, increasing the uniformity of taste characteristics in successively prepared coffee drinks, a total through-flow time for the brewing process is or can be predefined in which the total amount of brewing water is conducted through an amount of powdered coffee.

### BACKGROUND

The present invention relates to a method and to an associated apparatus for preparing a coffee beverage, in which method a pre-specifiable total quantity of brewing water is conducted through a quantity of coffee powder in a brewing process.

Commercially available coffee machines, such as fully automatic coffee machines or espresso machines, have a brewing chamber which is filled with coffee powder and in which the coffee powder may be compressed and through which hot water is then conducted under pressure. In some cases, machines of this kind additionally have a grinding mechanism with which coffee beans can be freshly ground.

EP 1 133 944 B1 proposes providing a mechanical control valve downstream of the brewing chamber, in which mechanical control valve a spring attempts to keep a valve body in the open position, and in which mechanical control valve the valve body can be closed by the pressurized coffee beverage against the pretensioning force of the spring in the closing direction. The described control valve device serves to keep the relative throughflow rate constant within certain limits. The spring pretension and therefore the desired flow rate can be manually regulated by an adjusting screw.

It has been observed that the taste and quality of the brewed beverage are subject to severe fluctuations in the case of known coffee machines. In addition to the type and quantity of coffee used, the degree of grinding of the coffee and the degree of compression of the coffee powder in the brewing chamber have a significant influence on the taste of the brewed coffee beverage in currently commercially available coffee machines. However, in addition to this, it is often also observed that the taste and quality of the coffee which is dispensed first after the coffee machine has been inoperative for a relatively long time falls extremely short of expectations and even has to be thrown away. However, fluctuations in the quality and taste of the dispensed coffee beverages can also arise during continuous operation under otherwise constant conditions.

### SUMMARY

Therefore, the object of the invention is to improve the taste quality of freshly brewed coffee beverages, at least however to improve the consistency in respect of the characteristic taste of coffee beverages which are prepared in succession.

The object is achieved by a method and a brewing apparatus having one or more features of the invention as discussed below.

In the case of a method of the abovementioned type, the object is achieved in that a total throughflow time in which the total quantity of brewing water is conducted through a quantity of coffee powder is pre-specified or pre-specifiable for the brewing process.

Whereas it was believed in the prior art that the significant influencing variables for the taste characteristics of coffee beverages are the degree of grinding of the coffee powder and the degree of compression of said coffee powder in the brewing chamber, sensory experiments carried out by the applicant have shown that coffee beverages which are virtually identical in respect of taste and quality can be prepared given regulation at a constant throughflow time with coffee powder with different degrees of grinding. This is an unexpected and extremely surprising finding since it was previously assumed that the taste of a coffee beverage is substantially influenced by the degree of grinding, that is to say the particle size, of the coffee powder and coffee grounds which are as fine as possible had to be used primarily for preparing coffee beverages having an “espresso”-like taste.

The present invention now arrives at the finding that, irrespective of the degree of grinding and the compression of the coffee powder, coffee beverages which are as good as indistinguishable in respect of taste and quality can be prepared when only the total throughflow time of the brewing water through the coffee grounds is the same. The question of whether the brewing water initially runs through more quickly or less quickly does not play a significant role here either, provided that these differences are compensated for only by adjustment of the throughflow rate to a constant total throughflow time over the entire brewing process. Therefore, if the brewing water initially runs through more quickly due to coarser grounds, it is provided according to the invention by corresponding adjustment that the remaining brewing water which is still to be conducted through runs through correspondingly more slowly, and vice versa.

Contrary to the previous beliefs in the technical field, the applicant was even been able to prepare coffee beverages having an “espresso”-like taste using somewhat coarser grounds, these coffee beverages being sensorily better than coffee beverages prepared using special, particularly fine espresso grounds, this being attributed, according to findings made by the applicant, to flavors being lost from the coffee due to excessively fine grinding.

Therefore, the brewing method according to the invention with a constant total throughflow time is suitable for virtually completely compensating for differences in the degree of grinding of the coffee powder, so that technically substantially simpler and therefore more cost-effective grinding mechanisms can be used when preparing coffee beverages from freshly ground coffee beans.

Secondly, the brewing method according to the invention allows beverages with different sensory characteristics to be extracted by changing the throughflow time in a targeted manner while using coffee powder having the same degree of grinding. Furthermore, optimizing the discharge time with a substantially constant quality of the coffee beverage allows the use of a smaller quantity of coffee powder, so that the brewing method according to the invention also leads to coffee powder being saved.

Setting the desired total throughflow time can be achieved within the scope of the present invention by controlling the throughflow rate over the duration of the brewing process. This involves, in particular, active flow control of the brewing water within the scope of the present invention. The throughflow rate of the brewing water over the brewing process is preferably controlled in an automated manner here.

In the brewing method according to the invention, it is accordingly provided that a total throughflow time in which the total quantity of brewing water is conducted through the coffee powder is pre-specified or pre-specifiable for the brewing process, that a value for the volume flow rate of the brewing water is determined continuously or at least several times during the brewing process, and the quantity of brewing water which has already been conducted through or is still to be conducted through is ascertained from the measured volume flow rate values, that the brewing water is conducted through under pressure and active flow control of the brewing water is carried out by a backpressure being applied by an adjustable backpressure valve, and that the throughflow rate of the brewing water is regulated during the brewing process, for the purpose of achieving the total throughflow time depending on the quantity of brewing water which has already been conducted through or is still to be conducted through, in such a way that the brewing process is carried out in the predetermined total throughflow time.

Coffee beverages of extremely high quality can be prepared by conducting the brewing water through under pressure. Additional flow control of the brewing water can be performed by controlling the pressure in this case. Control of the pressure can be realized in a simple manner by the rotation speed of a water pump with which the pressure is generated being controlled, for example by pulse-width modulation of the supply voltage. In this case, the pressure preferably lies in the range of between 2 and 25 bar, further preferably between 5 and 20 bar, and most preferably between 8 and 15 bar.

However, flow control of the brewing water is performed primarily by applying a backpressure by an outlet-end backpressure valve. This is particularly advantageous since a better crema is produced at a relatively high pressure, primarily for preparing espresso coffee beverages. The crema of an espresso contains the majority of the coffee flavor and is therefore particularly important for a high-quality espresso coffee beverage. In particular, an adjustable backpressure valve can be used for controlling the backpressure in this case.

In a preferred development of the invention, the controller is programmed in a self-learning manner, so that it ascertains from one or more immediately preceding brewing processes an amount by which a liquid throughflow through the backpressure valve in a start phase after the beginning of the brewing process has to be throttled once a liquid starts to flow in order to achieve the desired total throughflow time or an intended throughflow rate. Specifically, it has been found that a sharply fluctuating throughflow response, which may possibly be explained by thermal expansion effects or elastic material response in the region of the backpressure valve, has to be observed specifically in the start phase after the beginning of the brewing process. Particularly when using a needle valve which is driven by a stepper motor, the backpressure valve has to be adjusted, sometimes to a considerable extent, in the start phase in order to achieve the desired throughflow. Here, it has been found to be advantageous to learn from immediately preceding brewing processes and to take on the extent to which the valve has to be opened at the beginning of the brewing method and may possibly have to be adjusted once the liquid starts to flow.

This amount can be, for example, a number of steps by which the backpressure valve, which is driven by a stepper motor, is opened at the beginning of the brewing process and possibly closed again once the liquid starts to flow. This learned number of steps is then initially executed in a new brewing process, before the backpressure control according to the invention starts depending on the quantity of water which has already been conducted through or is still to be conducted through.

Ultimately, the method according to the invention can be used in all known coffee machines, such as portafilter machines for example. In a preferred embodiment, the brewing method is used in coffee machines with brewing chambers. In this case, the coffee powder is inserted into a brewing chamber of the coffee machine and the brewing water is conducted through the brewing chamber in the pre-specified total throughflow time. In the process, the throughflow time is controlled by actuating a backpressure valve which is arranged downstream of the brewing chamber in the throughflow direction.

In one refinement of the invention, the quantity of brewing water which has already been conducted through or is still to be conducted through is determined continuously or at least several times in order to actuate the backpressure valve depending on the quantity determined in this way, so that the brewing process is carried out in the pre-specified total throughflow time. Depending on whether still more or less brewing water has to be conducted through the brewing chamber given the pre-specified total quantity of brewing water in the time period remaining until the pre-specifiable total throughflow time is reached, the backpressure valve is opened again or closed again in order to increase or to reduce the volume flow rate.

The measurement variable and input value used for the backpressure flow control can be measured volume flow rate values which are ascertained, for example, by a throughflow sensor which is located in the water inlet. The quantity of brewing water which has already been conducted through can be determined from said volume flow rate values in a simple manner, for example by integration by a PID controller.

A brewing apparatus according to the invention accordingly has a controller by which a total throughflow time in which the total quantity of brewing water is conducted through a quantity of coffee powder is pre-specified or pre-specifiable for the brewing process. In particular, the controller can be in the form of a PID controller.

In addition, the brewing apparatus has a brewing chamber, to which pressure can be applied, for accommodating the coffee powder and for the brewing water to be conducted through during the brewing process, and has a pressure generator for generating a pressure which is applied to the brewing water in order to be conducted through the brewing chamber. In this case, a backpressure which is generated by a backpressure valve which is arranged downstream of the brewing chamber is controlled by the controller.

The brewing apparatus is also equipped with a measuring device for determining a volume flow rate of the brewing water. The controller ascertains, continuously or at least several times, the quantity of brewing water which has already been conducted through or is still to be conducted through from measured volume flow rate values and controls the throughflow rate of the brewing water during the brewing process depending on said ascertained quantity by the backpressure valve in such a way that the brewing process is carried out in the pre-specified total of throughflow time.

A measuring apparatus of this kind can preferably comprise a throughflow sensor. A throughflow sensor or flow meter of this kind measures the current throughflow rate or the volume throughflow rate through the pre-specified line cross section. The quantity of brewing water which has already been conducted through can be determined by integration with respect to the volume flow rate. A corresponding throughflow sensor can preferably be arranged either in a fresh water supply line, between a boiler for heating the brewing water and the brewing chamber or else downstream of the brewing chamber in the discharge for the completely brewed coffee beverage. A throughflow sensor of this kind can at the same time be used for portioning out the coffee beverage, that is to say for measuring out the pre-specifiable total quantity of brewing water, so that a further synergistic effect can be achieved as a result. A throughflow sensor of this kind is preferably located in the cold region, that is to say upstream of a boiler which is used for heating the brewing water, since the quantity of water can be measured most accurately at this point since it is not adversely affected by any steam bubbles and the accompanying increase in volume in the liquid.

In a particularly preferred embodiment, a backpressure valve in the form of a motor-operated throttle valve, in particular needle valve, can be used for generating a backpressure, the controller gradually opening or closing said backpressure valve by actuating a corresponding drive motor. However, as an alternative, the backpressure valve can also be designed as a clocked solenoid valve in which an average liquid throughflow can be adjusted by periodic opening and closing. In this case, the controller is designed to influence the average liquid throughflow by pre-specifying a switchover frequency and/or a duty factor between an opened and a closed state. A clocked solenoid valve of this kind is preferably operated at a high switching frequency of below 1 Hz, preferably between 1 and 60 Hz, further preferably between 5 and 30 Hz and most preferably between 10 and 20 Hz, so that a stable average liquid throughflow is established.

The present invention also relates to a coffee machine comprising an abovementioned brewing apparatus. A coffee machine or fully automatic coffee machine of this kind can preferably have a grinding mechanism for grinding coffee beans into coffee powder. Due to the synergistic effect of the invention, this grinding mechanism can, in order to compensate for differences in the degree of grinding and to prepare outstanding tasting coffee beverages even with relatively coarse grinding, be of substantially simpler or technically less complicated design than the grinding mechanisms which are currently used in premium machines and are designed for particularly fine coffee grindings. In addition, the brewing apparatus according to the invention can preferably also be used in a so-called single-serve coffee machine, that is to say a coffee machine which uses pre-portioned coffee capsules or coffee pods, further preferably in a capsule coffee machine.

### BRIEF DESCRIPTION OF THE DRAWINGS

Further advantages and properties of the invention can be gathered with reference to the exemplary embodiments and the attached drawings, in which:

FIG. 1 shows a schematic water flow diagram of the brewing apparatus according to the invention,

FIG. 2 shows a sectional illustration through a needle valve which is used within the scope of the invention for backpressure flow control,

FIG. 2A shows a view of a detail of the valve needle and valve opening from FIG. 2,

FIG. 3 shows a timing diagram for the control signals during a brewing process,

FIG. 4 shows a time graph of the setpoint value and of the measured actual value of the backpressure flow control during a brewing process,

FIG. 5 shows a time graph containing the profile of a control curve for the valve adjustment in steps of a stepper motor which serves to actuate the valve and the actual value of the throughflow rate which is measured by a throughflow sensor, and

FIG. 6 shows a second exemplary embodiment of a brewing apparatus according to the invention.

### DETAILED DESCRIPTION OF THE PREFERRED EMBODIMENTS

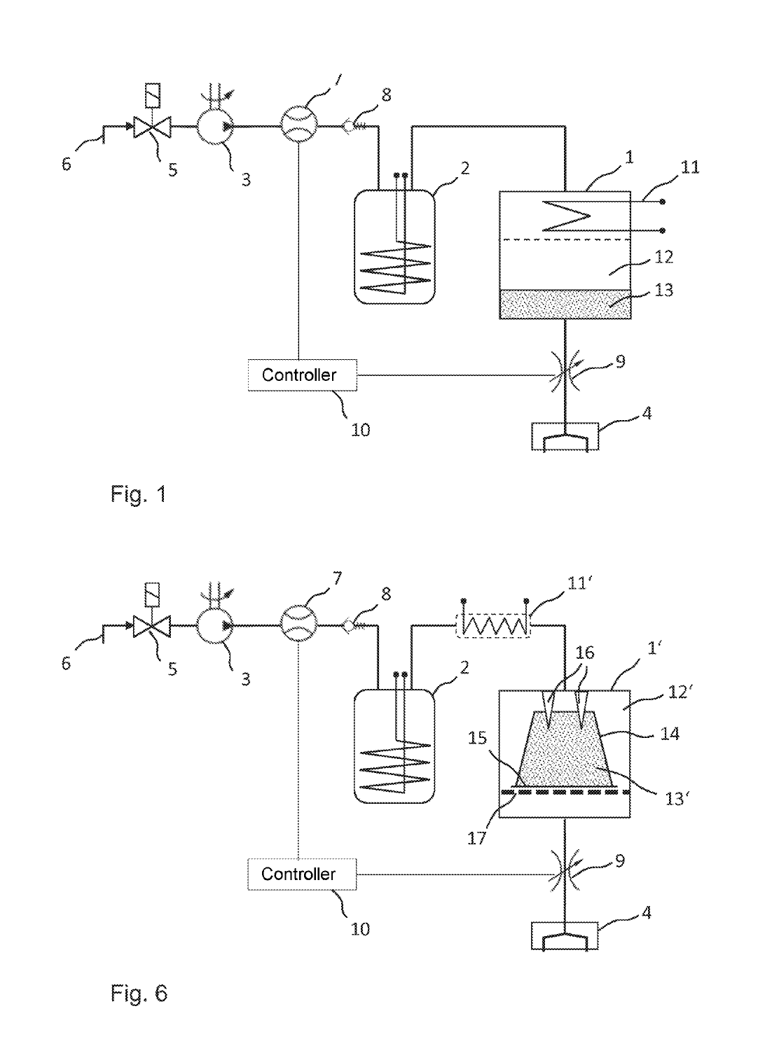

FIG. 1 shows, in a so-called water flow diagram, the design of a brewing apparatus for preparing coffee beverages which can be used, for example, in a fully automatic coffee machine. The brewing apparatus comprises a brewing assembly 1, a hot water boiler 2, an inlet-side water pump 3 and a discharge 4 for dispensing freshly brewed coffee beverages. A main water valve 5, by which the brewing apparatus is connected to a drinking water supply line 6, is located upstream of the water pump 3 in the flow direction. At the delivery end, the pump 3 is connected to the inlet of the hot water boiler 2 by a throughflow sensor 7, often also called a flow meter, and a non-return valve 8. Hot water from the boiler 2 is supplied to the brewing assembly 1. A controllable backpressure valve 9, which is actuated by a controller 10 depending on the measurement values of the throughflow sensor 7, is located between the brewing assembly 1 and the discharge 4. In this case, the controller 10 can be realized by a microprocessor in which other open-loop and closed-loop control processes can be implemented in a fully automatic coffee machine.

The brewing assembly comprises, in a manner which is known per se, a heater 11 with which the brewing assembly is preheated and kept warm, and a brewing chamber 12 which is filled with portioned-out, freshly ground coffee powder 13. A brewing assembly, which can be used within the scope of the present invention, is described, for example, in EP 2561778 A1, the entire content of said document being incorporated here by reference in order to avoid unnecessary repetition.

The brewing assembly 1 is designed such that it can be opened in order to insert a portioned-out quantity of coffee powder which has first been freshly ground in portions in a grinder of the fully automatic coffee machine. In addition, the remaining coffee grounds can be discarded into a grinds container after the brewing process when the brewing assembly is open. The brewing assembly also has a movable plunger (not illustrated) which compresses the inserted coffee powder against a brewing screen which is located in the brewing chamber. After the piston is retracted, pressurized brewing water can flow through the coffee powder which is compressed in this way.

The pressure which is generated by the pump 3 and at which the brewing water is conducted through the brewing chamber 12 is typically approximately 8 to 12 bar, without the invention being restricted to this however. In conventional coffee machines, this pressure of the brewing water drops across the coffee mass 13 which is compressed in the brewing chamber 12. The rate at which the brewing water runs through the coffee powder 13 is critically dependent on the degree of grinding of the coffee powder, the type of coffee, the quantity and the degree of compression in this case. However, in the brewing apparatus shown here, the pressure drop takes place primarily on the backpressure valve 9 which is arranged downstream of the brewing chamber 12 and with which the throughflow rate of the powder through the brewing chamber 12 is controlled in a targeted manner by the controller 10, specifically depending on the actual, measured throughflow rate in the throughflow sensor 7.

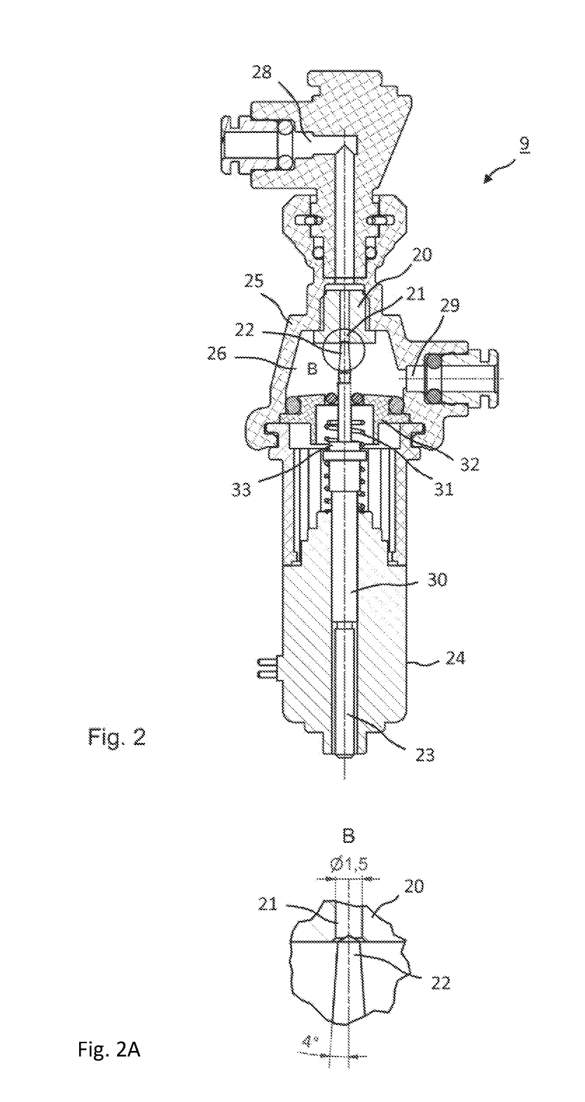

In the exemplary embodiment, the backpressure valve 9 is in the form of a needle valve which is driven by a stepper motor and is illustrated in section in FIG. 2. The core element of the needle valve is a valve insert 20 with a continuous valve opening 21 which a valve needle 22 enters. These elements are illustrated in enlarged form in a detail B in FIG. 2A. In the exemplary embodiments, the valve opening 21 has a diameter of 1.5 mm. The valve needle 22 has a very steep angle of inclination of only 4°.

The valve needle 22 is supported by a spindle 23 which is driven by a stepper motor 24. The valve insert 20 and the valve needle 22 are accommodated in a valve housing 25 to which the stepper motor 24 is connected by a bayonet fitting. The valve chamber 26 which is formed by the valve housing 25 is sealed off at the bottom from the stepper motor 24. An inlet 28 which is connected to the brewing assembly 1 is located at the top end of the valve chamber 26. An outlet 29, which is connected to the discharge 4 of the coffee machine, is located on the side of the valve housing 25.

The spindle 23 interacts with a spindle nut 30 which is held on the housing of the stepper motor 24. A pretensioning spring 31, which is supported on a support plate 32 on the bottom side of the valve housing 25 and on a collar 33 which is connected to the valve needle 22, pretensions the valve needle 22 or spindle 23 against the spindle nut 30 and therefore cancels out any possible play in the spindle drive.

The valve housing 25, the valve insert 20 and the valve 22 are comprised of plastic for hygiene reasons. In particular, high temperature-resistant thermoplastics, in particular PEEK (polyether ether ketone) have proven particularly suitable for the valve insert and the valve needle. As an alternative, the valve insert and the valve needle can also be produced from stainless steel. The valve housing can be comprised of, for example, PPS or PPSU (polyphenylene sulfide or polyphenylene sulfone).

In order to achieve a suitable valve response, a valve needle with a conical profile is used, wherein the opening angle is between 2 and 15°. The best control response was ascertained with a valve needle having a conical profile with an opening angle of 4°, this being used in the exemplary embodiment.

The stepper motor 24 can be selectively actuated in full steps or in steps of one eighth. At the selected spindle transmission ratio, a full step corresponds to a stroke of 0.021 mm. The spindle stroke between complete opening and closing of the needle valve is approximately 100 full steps. The stepper motor is actuated in full steps for the purpose of rapid opening and closing. However, in control mode, this is changed to steps of one eighth. The stepper motor can also be actuated at a different coil current, 50 and 100 mA. For opening purposes and in control mode, the stepper motor is in each case actuated with the full coil current; when closing the needle valve, the coil current is lowered in order to close the valve with a lower force, so that the valve needle 22 does not become stuck in the valve opening 21 due to the high needle steepness.

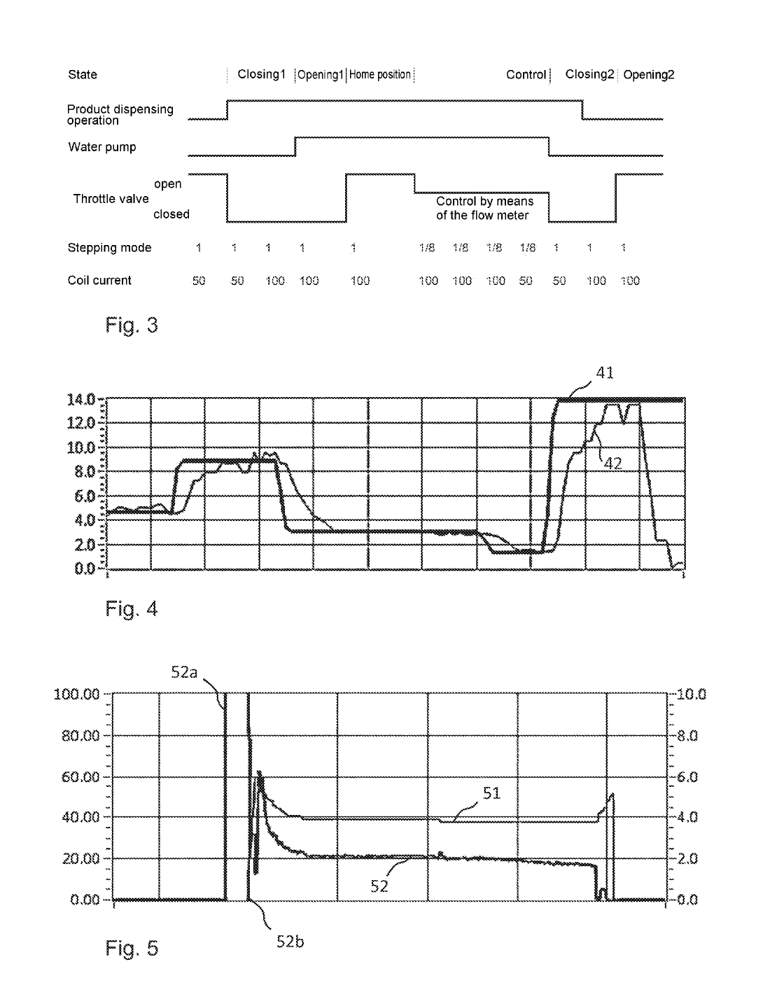

FIG. 3 shows the time sequence when actuating the brewing apparatus. Before the beginning of a product dispensing operation, the backpressure valve is completely open. If a product dispensing operation begins by a user performing a product selection operation and starting the preparation process using corresponding input means, the backpressure valve is closed. As explained, closing is performed in the full step mode with a reduced coil current. In the next step, the water pump starts up and generates a water pressure. Hot water from the boiler 2 now flows to the brewing assembly 1 until said brewing assembly is full. The backpressure valve 9 remains closed for this time. If the flow of water comes to a stop because the brewing assembly 1 is filled with water, the backpressure valve 9 is then opened and the brewing process begins.

Actuation of the stepper motor is now changed over to the mode performed in one eighth of a step and the backpressure valve is controlled by the controller 10 on the basis of the measurement values of the throughflow sensor 7. After conclusion of the brewing process, the water pump switches off. In addition, the backpressure valve is closed. This prevents any remaining liquid which may still be contained in the lines from dripping out of the discharge 4 of the coffee machine. The product dispensing operation is now concluded and the user is shown by a graphical user interface that he can remove the beverage container containing the selected beverage.

Finally, the throttle valve is completely opened again a predetermined time period after conclusion of the product dispensing operation. This has the background that, on account of the high needle steepness and thermal expansion of the valve insert 20 and the valve needle 22, the valve needle 22 could become stuck in the valve opening 21 due to so-called shrinking-on. In a worst case scenario, it would no longer be possible to open the valve after cooling down. In order to prevent this, the valve is opened, as described, after conclusion of the product dispensing operation, but in good time before excessive cooling.

FIG. 4 shows, by way of example, the subsequent response of the actual value for the throughflow rate for manually set setpoint values. The bold solid line 41 represents the setpoint value, which is set by the valve opening of the backpressure valve 9, for the throughflow rate in milliliters per second (ml/s). The thin line 42 shows the actual values which are measured by the throughflow sensor 7. A slight time delay of approximately 0.8 seconds between the setpoint value curve 41 and the actual value curve 42 is the result of the throughflow sensor 7 being arranged upstream of the boiler 2 in the cold water region. As an alternative, a throughflow sensor could also be arranged directly upstream or directly downstream of the brewing assembly 1.

The time profile of the control curve and the actual value of the throughflow rate, which is measured by the throughflow sensor, are plotted in FIG. 5. The left-hand-side ordinate relates to the position of the needle valve in steps of the stepper motor. The associated valve position is illustrated as curve 51. The actual value curve 52 for the throughflow rate relates to the right-hand-side ordinate in milliliters per second (ml/s).

At the beginning of a product dispensing operation with the water pump switched on, the throughflow rate initially increases rapidly and reaches a peak value in a region 52a, without the backpressure valve 9 having been opened. This region, until the throughflow rate returns to zero again at a time 52b, relates to filling of the brewing assembly 1. As soon as the brewing assembly 1 is filled, the controller 10 opens the valve 9 until throughflow starts again. Due to the elastic properties in the valve and a large number of further effects, such as the valve needle possibly becoming stuck until opening, a relatively large number of motor steps are required for the purpose of initial opening of the backpressure valve 9. Depending on the operating situation of the needle valve 9, said motor steps may well be 20 to 40 stepper motor steps, for which reason this initial opening can preferably also be executed with a full step range.

After a current flow through the brewing chamber 12 initially starts, the backpressure valve 9 has to be immediately closed again to a certain extent. The control arrangement reacts very sensitively in this first start region. Thermal expansion and elasticity of the valve may, according to findings made by the applicant, be the reason that the control arrangement exhibits this oscillating response until it has stabilized. For this reason, it is advantageous for this start response to implement, after a volume flow starts, self-learning control which ascertains, from previous brewing processes, a measure for the number of steps for which the needle valve 9 has to be adjusted downward or closed again after initial opening and starting of the volume flow.

Coffee beverages with different backpressures and therefore different characteristic tastes can be brewed using the described brewing method. The backpressure can be changed during the brewing process depending on the measured volume flow rate. For example, the volume flow rate can therefore be regulated at a constant, pre-specified or pre-specifiable discharge volume flow rate. However, due to the nondeterministic transient response, it has proven to be particularly advantageous to regulate at a constant discharge time, that is to say to accelerate or to decelerate the throughflow rate of the brewing water in a targeted manner depending on the brewing water which has already flowed through or is still to flow through, so that the pre-specified total throughflow time is achieved for a total quantity of brewing water, which is pre-specified for the selected beverage, overall. In this way, it is possible to ensure that all beverages of the same beverage type, for example espresso or lungo, are prepared with the same total throughflow time in each case. According to the findings of the invention, this leads to a very high degree of reproducibility and consistency in the coffee quality for a respectively pre-specified type of beverage.

For any type of beverage, it is possible to ascertain or test a throughflow time which is optimal in respect of the customer's wishes, the coffee quality being considerably improved by said throughflow time in comparison to conventional coffee machines. In addition, by virtue of optimizing the discharge time, a reduction in the quantity of coffee used can be at least partially compensated for, so that a saving in the amount of coffee required is achieved together with a comparatively consistent quality. Finally, differences in respect of the degree of grinding of the coffee have no effect or at best a minor effect on the coffee quality of the coffee beverage which is brewed according to the invention, so that less complicated grinding mechanisms can be used in fully automatic coffee machines according to the invention. Finally, experiments performed by the applicant have produced the astounding finding that even slightly better sensory results are achieved with somewhat coarser grinds than with the very fine grind used to date, in particular in the field of the espresso beverage type.

The longer the throughflow time is selected to be using the brewing method according to the invention, the higher the extraction yield of the non-volatile contents in the prepared coffee beverage and the greater the sensory perception in respect of the taste characteristics (acidity, bitterness) and also in respect of the astringency. This allows targeted control and optimization of the coffee beverage produced according to the invention.

As an alternative to the needle valve used in the exemplary embodiment, other control valves, for example a geared throttle valve, can be used as the backpressure valve within the scope of the present invention. Similarly, the use of a clocked solenoid valve, which opens and closes in rapid sequence, preferably at a frequency of the order of magnitude of approximately 10 Hz, and in this way creates an average volume flow rate through the intermittently operated solenoid valve, as the backpressure valve is also covered by the scope of the invention. In this case, the average volume flow rate can be set by pre-specifying a frequency and/or a duty factor between the opened and closed state.

Similarly, as an alternative or in addition to backpressure control, controlling the pressure which is generated by the water pump 3 is also covered by the scope of the invention.

FIG. 6 shows a further exemplary embodiment of a brewing apparatus. In contrast to the brewing apparatus shown in FIG. 1, the one brewing unit 1′ is designed for a single-serve coffee machine for operation with coffee capsules 14 here. The brewing chamber 12′ is designed to receive coffee capsules. Coffee capsules of this kind can be manufactured from aluminum or plastic and are pre-filled with portioned-out coffee powder 13′ and sealed, for example as shown in FIG. 6 by a membrane on the bottom side of the capsule 14.

In the exemplary embodiment, the brewing chamber 12′ is, in a manner which is known per se, in the form of a capsule cage which encloses an inserted coffee capsule 14. On the top side, the capsule 14 is pierced by one or more spikes 16. This can be performed in an automated or manual manner. On the bottom side, the capsule is pressed against a carrier plate 17 which is provided with passages, a so-called pyramidal plate. After starting of the brewing process, hot water is pressed from the hot water boiler 2 into the capsule 14 under pressure. If the pressure within the capsule 14 is high enough, the membrane 15 on the bottom side of the capsule 14 gives way and the coffee beverage which is brewed within the capsule 13 can flow through the now perforated membrane 15 and the passages in the pyramidal plate 17 in the direction of the discharge 4. In addition or as an alternative to the hot water boiler 2, a throughflow heater 11′ can be arranged in the water inlet of the brewing unit 1′, the brewing water being heated or reheated by said throughflow heater.

As in the case of the first exemplary embodiment as well, a backpressure valve 9 is arranged in the outlet line between the brewing chamber 12′ and the discharge 4, it being possible for the throughflow to be controlled by the controller 10 depending on the values which are measured by the throughflow sensor 7. It is possible to regulate at a pre-specified flow rate, but preferably at a pre-specified total throughflow time of a pre-specified quantity of brewing water, by a backpressure flow control in this case too.

Although the differences in the degree of grinding of the supplied coffee powder 13′ play a less significant role in industrially produced and pre-filled coffee capsules 14, in a capsule coffee machine a significantly higher consistency of the sensory characteristics of the quality of the dispensed coffee beverages can be ensured by setting an identical total throughflow time for all coffee beverages which are prepared in succession. In addition, the taste characteristics can be matched to the preferences of a user by varying or optimizing the total throughflow time.

It goes without saying that the brewing method according to the invention can be used with any types of single-serve coffee machines, both those for operation using coffee capsules and also those for operation using coffee pods. Similarly, the quantity of brewing water which is to be conducted through can be changed and the total throughflow time can be accordingly adjusted, for example for the purpose of dispensing different coffee beverages or else for producing single or double servings, within the scope of the brewing method according to the invention.

1. A method for preparing a coffee beverage, comprising:
conducting a pre-specifiable total quantity of brewing water through a quantity of coffee powder (13) in a brewing process,
pre-specifying a total throughflow time in which the pre-specifiable total quantity of brewing water is conducted through the coffee powder (13) for the brewing process,
determining a value for a volume flow rate of the brewing water continuously or at least several times during the brewing process, and ascertaining a quantity of brewing water which has already been conducted through or is still to be conducted through the brewing chamber from the volume flow rate values that are measured,
conducting the brewing water through the brewing chamber under pressure and carrying out an active flow control of the brewing water by applying a backpressure by an adjustable backpressure valve (9), and
regulating the throughflow rate of the brewing water during the brewing process, for achieving the total throughflow time depending on the quantity of brewing water which has already been conducted through or is still to be conducted through, such that the brewing process is completed in the predetermined total throughflow time.

2. The brewing apparatus as claimed in claim 1, further comprising, depending on how much of the brewing water still has to be conducted through the brewing chamber in order to achieve the pre-specifiable total quantity in the time period remaining until the pre-specified total throughflow time is reached, further opening or further closing the backpressure valve in order to increase or to reduce the volume flow rate.

3. The method as claimed in claim 1, further comprising ascertaining an amount by which a liquid throughflow through the backpressure valve (9) in a start phase after a beginning of the brewing process has to be throttled in order to achieve the total throughflow time from one or more immediately preceding brewing processes.

4. The method as claimed in claim 1, further comprising controlling the flow of the brewing water additionally by controlling a pressure thereof.

5. The method as claimed in claim 1, wherein the flow control of the brewing water is performed in an automated manner.

6. The method as claimed in claim 1, further comprising inserting the coffee powder (13) into a brewing chamber (12) and conducting the brewing water through the brewing chamber (12) in the pre-specified total throughflow time, and controlling the throughflow time by actuating the backpressure valve (9) which is arranged downstream of the brewing chamber (12) in a throughflow direction.

7. A brewing apparatus for preparing a coffee beverage by conducting a pre-specifiable total quantity of brewing water through a quantity of coffee powder (13) during a brewing process, the brewing apparatus comprising:
a controller configured to pre-specify a total throughflow time in which a total quantity of brewing water is conducted through the quantity of coffee powder (13) for the brewing process,
a flow measuring device (7) that determines a volume flow rate of the brewing water,
a brewing chamber (12), to which pressure can be applied, adapted to receive the coffee powder (13) and through which the brewing water is conducted during the brewing process,
a pressure generator for generating a pressure which is applied to the brewing water in order to be conducted through the brewing chamber (12), and
an adjustable backpressure valve arranged downstream of the brewing chamber that is adapted to generate a backpressure;
the controller is configured to ascertain, continuously or at least several times, the quantity of brewing water which has already been conducted through or is still to be conducted through from measured volume flow rate values signaled from the flow measuring device and to control the throughflow rate of the brewing water during the brewing process depending on said ascertained quantity by actuating the backpressure valve such that the brewing process is carried out in the pre-specified total throughflow time.

8. The brewing apparatus as claimed in claim 7, wherein the backpressure valve comprises a motor-operated needle valve (9), and the controller (10) is configured to further open or close the needle valve (9) by actuating a drive motor (24) of the backpressure valve.

9. The brewing apparatus as claimed in claim 7, wherein the controller is configured to ascertain from one or more immediately preceding brewing processes an amount by which a liquid throughflow through the backpressure valve (9) in a start phase after a beginning of the brewing process has to be throttled in order to achieve the total throughflow time, and the controller, in the start phase of a new brewing process, is configured to adjust the backpressure valve (9) to the amount ascertained and begins control of the throughflow rate starting from said amount.

10. The brewing apparatus as claimed in claim 9, wherein the backpressure valve is driven by a stepper motor and the amount which is ascertained by the controller is a number of steps by which the backpressure valve is opened at the beginning of the brewing process.

11. A coffee machine comprising the brewing apparatus as claimed in claim 7, and a grinding mechanism for grinding coffee beans into coffee powder.

12. A single-serve coffee machine comprising the brewing apparatus as claimed in claim 7.

13. A capsule coffee machine comprising the brewing apparatus as claimed in claim 7.
